(19) United States
(12) Patent Application Publication
(10) Pub. No.: US 2024/0226807 A1
(43) Pub. Date: Jul. 11, 2024

(54) ENERGY OPTIMIZATION IN COMBINED WASTE GAS TREATMENT AND CARBON CAPTURE SYSTEMS

(71) Applicant: UOP LLC, Des Plaines, IL (US)

(72) Inventors: Elizabeth Jensen, Des Plaines, IL (US); Alec A. Sheir, Tulsa, OK (US); William J. Whyman, Collinsville, OK (US)

(21) Appl. No.: 18/525,972

(22) Filed: Dec. 1, 2023

Related U.S. Application Data
(60) Provisional application No. 63/479,235, filed on Jan. 10, 2023.

(51) Int. Cl. B01D 53/34; B01D 46/00; B01D 46/02; B01D 53/50; B01D 53/56; B01D 53/62; B01D 53/77; B01D 53/81; F28C 3/02

(52) U.S. Cl. CPC B01D 53/343; B01D 46/0032; B01D 46/02; B01D 53/508; B01D 53/56; B01D 53/62; B01D 53/77; B01D 53/81; F28C 3/02; B01D 2257/302; B01D 2257/404; B01D 2257/504; B01D 2257/708; B01D 2258/0283

(57) ABSTRACT

A method and apparatus for treating waste gas for an solvent-based carbon capture unit. The process involving the use of a dry sorbent injection (DSI) unit to remove sulfur compounds and fine particulate matter from flue gas are described. The treated flue gas is used to preheat the rich solvent stream from the carbon capture unit. Flue gas from an FCC regenerator, for example, is used to make superheated steam and saturated steam. The process allows for increased thermal energy recovery, decreased water utility and increased equipment reliability.

### RELATED APPLICATIONS

This application claims priority to U.S. Provisional Patent Application Ser. No. 63/479,235 filed on Jan. 10, 2023, the entirety of which is incorporated herein by reference.

### BACKGROUND

Flue gas treatment varies depending on the requirements for contaminant removal and the destination of the purified flue gas. Often times, treatment of flue gas waste streams from units involves the use of wet gas scrubbing technology, such as a caustic scrubber, to remove sulfur compounds and particulate from the flue gas. The flue gas waste stream is cooled from a temperature of 400-500° F. to a temperature of 140-194° F. using a water quench. The cooled flue gas is contacted with a reactant such as NaOH which reacts with the sulfur compounds to form Na₂SO₃ and/or Na₂SO₄ and water, which are removed along with some particulate matter present in the flue gas. The flue gas is then treated to remove the rest of the catalyst fines and other particulate. The flue gas can optionally be heated and treated to remove nitrogen compounds. The treated flue gas is then sent to the carbon capture unit for CO₂ recovery.

However, the capital costs of the system are high, as are the operating costs due to the use of NaOH, water, electricity, flocculants, and slurry handling. Moreover, the system requires a large area and is maintenance intensive. The wet scrubber process has a high make-up water requirement due to water quenching and the use of aqueous NaOH. The system also suffers from corrosion problems related to the use of H₂SO₄, and spray nozzle fouling concerns due to the presence of salts. A substantial amount of sensible energy is not recovered because of SO₃ (acid) dew point limitations. The poor energy recovery is due to the corrosion risks and poor thermal profile (due to the configuration of the treatment process units and subsequent temperature requirements). This may result in a negative energy balance and a carbon intensive process.

Therefore, there is a need for improved processes for treating waste gas containing sulfur compounds and fine particulate matter.

### BRIEF DESCRIPTION OF THE DRAWINGS

FIG. 1 is an illustration of a conventional solvent-based carbon capture process.

FIG. 2 is an illustration of one embodiment of solvent-based carbon capture process according to the present invention.

FIG. 3 is an illustration of one embodiment of a flue gas treatment process for a solvent-based carbon capture process according to the present invention.

FIG. 4 is an alternate embodiment of the flue gas treatment process of FIG. 3

### DESCRIPTION OF THE INVENTION

The process involves the use of a dry sorbent injection (DSI) unit to remove sulfur compounds from waste gas streams. The waste gas is sent to a DSI unit to remove the sulfur compounds and particulate, and then to a primary heat exchanger to preheat the rich solvent stream from the solvent-based carbon capture unit. Because with a traditional wet gas scrubber, the flue gas temperature is limited by the acid dew point temperature, additional thermal energy can be recovered from the waste gas with the process of the present invention. The primary heat exchanger pre-heats a rich solvent stream from a carbon capture system, decreasing the amount of heat needed in the solvent-based carbon capture system to heat the rich solvent stream before the regenerator. For the solvent-based carbon capture system, this invention reduces the steam required to heat the rich solvent stream, thus, decreasing the carbon footprint of the process as well as decreasing the capital and operating expenses.

The benefits of the integration of the waste gas pretreatment with the solvent-based carbon capture system include a decrease in the steam demand of solvent-based carbon capture system; reduced size of the steam heater in the solvent-based carbon capture system due to reduced steam demand; water utility reduction; reduction in the size of the absorber column due to decreased inlet mass flow.

Optional additional heat exchangers can be used to heat boiler feed water, thermal oil, or combustion air, for example for other end uses. If the additional heat exchanger is a condensing economizer, there will be a decreased saturation temperature of the inlet gas to the solvent-based carbon capture system; and the decreased saturation temperature will change the energy balance of the solvent-based carbon capture system, and potentially increase the CO₂ capture.

In some embodiments, the waste gas is flue gas from an FCC regenerator, for example, which can be used to make superheated steam and saturated steam.

The source of the waste gas stream is not particularly limited. Suitable sources of waste gas streams include, but are not limited to, coal fired power plants, fluidized catalytic cracking (FCC) process units, cement plants, and the like.

The increased energy recovery is directly correlated with the SO_{X} content (acid dewpoint) of flue gas. By utilizing a dry sorbent injection (DSI) system, the unharvested sensible energy can be captured, substantially improving the energy efficiency and avoiding negative energy balances.

The process results in a substantial increase in energy recovery due to the addition of a primary heat exchanger downstream of the DSI and the SCR and an improved heat profile (i.e., less reheating is needed for heating the effluent). Energy optimization is realized by avoiding the need to cool flue gases to adiabatic saturation temperature (e.g., 140-194° F.). Instead, the temperature of the effluent after the sulfur removal and particulate removal by the dry scrubber system is maintained. Therefore, the SO₃ dew point limitation on the downstream equipment is removed, and additional sensible energy can be removed up to the water dew point by implementing a gas/gas and/or gas/liquid heat exchanger downstream of the dry scrubber system and nitrogen removal unit (e.g., in the form of SCR). The recovered sensible energy can be used for pre-heating the rich solvent stream from the carbon capture system. In addition, in some embodiments, one or more additional heat exchangers can be used to recover additional sensible energy. The recovered sensible energy from the additional heat exchangers can be used for preheating boiler feed water used in the HRSG boiler and/or catalyst cooler, thereby reducing or eliminating the possibility for negative energy balances. Combustion air and/or oil feed stock can be heated in the additional heat exchangers. Low-pressure (LP) or medium pressure (MP) steam can be produced which can be used in main refinery process, the fluidized dehydrogenation process, and/or the solvent based carbon capture unit. The value created by additional energy recovery will increase with increasing sulfur content in the flue gas, as this limits the sensible heat recovery which can be done, due to SO₃ dewpoint limitations.

The novel configuration allows for up to 36% additional thermal energy recovery with the carbon capture system by cooling the flue gas to about 341° F. rather than about 450° F. (decreasing the acid dew point of the flue gas stream). The increased thermal energy recovery can be used to decrease the steam consumption of the solvent-carbon capture system.

The additional energy can be recovered by cooling the flue gas from 341° F. to 300° F. The recovered energy can be used to preheat combustion air for CO-combustor (if present) and/or DFAH, and/or boiler feed water for the HRSG and/or catalyst cooler (if present). The LP or MP stream can be used in the alternative processes in the main refinery as discussed above.

Sulfur removal upstream of the primary heat exchanger reduces tube corrosion risks and greatly increases system reliability. The process reduces or eliminates corrosion (H₂SO₄) concerns in the sulfur removal step by staying above the water and acid dewpoint. Avoiding operation in the corrosive regime eliminates the need for a stainless steel flue gas scrubber; the complete system can be made from carbon steel (decreases the overall systemcapital expense).

Moreover, since the sulfur is removed, the flue gas outlet temperature can be decreased from about 450° F. to about 300° F. As discussed above, the additional thermal energy recovery can be included from 341° F. to 300° F. If the additional heat exchanger is used to preheat boiler feed wate (BFW), additional preheating (in the main process) of the BFW to 350° F. is no longer required (typical BFW is 230-250° F.) which eliminates the need for circulating (steam drum) water pumps (at one third of the BFW flow) and the dew point issues of BFW. This results in improved reliability, reduced maintenance requirements (e.g., fewer tube failures resulting on fewer tube changes), and decreased capital expenses.

Due to the configuration of the waste gas treatment process units via the invention, at the inlet of the quench column, the temperature is greatly reduced comparted to the temperature at the inlet of the wet gas scrubber in the conventional treatment process. The reduction in temperature, significantly reduces the make-up water due to the adiabatic saturation temperature of the inlet gas stream. Because utility water is considered a scarce resource, the water metric for the system is significantly improved. The make-up water consumption can be reduced by up to 60%.

The invention also eliminates spray nozzle fouling concerns by avoiding the need for complex slurry handling, white plumes as a result of water condensation, and blue plumes as a result of H₂SO₄ aerosol emissions. In addition, NOₓ reductions up to 21% may be achieved when using NaHCO₃ and the system pressure drop can be up to 50% lower. When using KOH as scrubbing reagent, the scrubbed residue will be K₂SO₄/KNO₃ fertilizer (about 4.47% CAGR) with a saleable value.

One aspect of the invention is a method for treating a waste gas stream in a process for capturing carbon dioxide wherein the waste gas stream comprises one or more of H₂O, CO₂, CO, N₂, O₂, SO_{X}, NO_{X}, HCl, Cl₂, dioxins, furans, organic acids, heavy metals, catalyst fines, and fine particulate matter. In one embodiment, the method comprises: reacting one or more of H₂O, CO₂, CO, N₂, O₂, SO_{X}, NO_{X}, HCl, Cl₂, dioxins, furans, catalyst fines, fine particulate matter or a mixture thereof in the waste gas stream with a reactant in an SO_{X} reaction section comprising a dry sorbent injection (DSI) reactor, wherein the reactant comprises one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂) to form a SO_{X} reactor effluent stream comprising one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), dioxins, furans, organic acids, heavy metals, catalyst fines, and fine particulate matter. The inlet temperature for the SO_{X} reactor is typically in the range of 200° C.-400° C. with a pressure of −3 kPa(g) to 50 kPa(g). The outlet temperature for the SO_{X} reactor is typically in the range of 150° C.-400° C. with a pressure of −5 kPa(g) to 50 kPa(g).

The SO_{X} reactor may contain a reactant, such as one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂). The SO_{X} reactor converts one or more of the compounds in the waste gas stream.

The SO_{X} reactor effluent stream is filtered to remove one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), dioxins, furans, organic acids, heavy metals, catalyst fines and fine particulate matter to form a filtered SO_{X} reactor effluent stream. The inlet temperature for the filtration section is typically in the range of 150° C.-350° C. with a pressure of −5 kPa(g) to 50 kPa(g). The outlet temperature for the filtration section is typically in the range of 150° C.-350° C. with a pressure of −7 kPa(g) to 50 kPa(g).

The SO_{X} reactor effluent stream may be filtered using any suitable filter unit. Suitable filter units include, but are not limited to, a bag filter or an electrostatic precipitator.

In some embodiments, the filter material stream formed by filtering the SO_{X} reactor effluent is divided into two portions, with the first portion being recycled to the DSI reactor, and the second portion being recovered.

The filtered SO_{X} reactor effluent stream is sent to a NO_{X} reactor section where one or more of H₂O, CO₂, CO, N₂, O₂, dioxins, furans, organic acids, heavy metals, catalyst fine, and fine particulate matter in the filtered SO_{X} reactor effluent stream is reacted in a NO_{X} reactor section comprising a selective catalytic reduction (SCR) reactor to form a NO_{X} reactor effluent stream with a reduced level of nitrogen-containing compounds compared to the SO_{X} reactor effluent stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NO_{X} reactor section where it reacts with the NO_{X} present in the filtered SO_{X} reactor effluent stream. The inlet temperature for the NO_{X} reactor section is typically in the range of 150° C.-300° C. with a pressure of −8 kPa(g) to 50 kPa(g). The outlet temperature for the NO_{X} reactor section is typically in the range of 150° C.-350° C. with a pressure of −9 kPa(g) to 50 kPa(g).

Optionally, dioxin, furan, or both can be removed from the NO_{X} reactor effluent stream in a dioxin-furan removal section to form a treated NO_{X} reactor effluent stream consisting essentially of one or more of H₂O, CO₂, CO, N₂, and O₂.

A rich solvent stream from a carbon capture section is pre-heated with the NO_{X} reactor effluent stream or the treated NO_{X} reactor effluent stream thereby reducing a temperature to 130° C. to 200° C. and staying above the dew point of water forming a cooled effluent stream and a pre-heated rich solvent stream. The inlet temperature for the primary heat exchanger is typically in the range of 150° C.-350° C. with a pressure of −9 kPa(g) to 50 kPa(g). The outlet temperature for the primary heat exchanger is typically in the range of 100° C.-150° C. with a pressure of −11 kPa(g) to 50 kPa(g).

The cooled effluent stream is introduced into the carbon capture section.

In some embodiments, there is a combined quench/polishing column between the NO_{X} reactor and the carbon capture section. In this case, the cooled effluent stream is quenched in the quench section of the combined quench/polishing column to form a quenched stream before introducing the cooled effluent stream into the carbon capture section, and a second reactant is contacted with the quenched stream in the polishing section of the combined quench/polishing column to form a liquid stream and a purified outlet gas stream with a reduced temperature compared to the cooled effluent stream. The liquid stream comprises one or more of H₂O, Na₂SO₄, Na₂SO₄, NaHSO₃, Na₂CO₃, CaSO₄, CaCO₃, K₂SO₄, and K₂CO₃. The reactant comprises one or more of NaOH, KOH, CaOH, NaHCO₃, Na₂CO₃, NaHCO₃·Na₂CO₃·2(H₂O), CaCO₃ and Ca(OH)₂. The purified outlet gas stream is introduced into the carbon capture section.

In some embodiments, the rich solvent stream is pre-heated with the filtered NO_{X} reactor effluent stream or the treated outlet stream using a gas/gas heat exchanger or a gas/liquid heat exchanger or a condensing heat exchanger or a plate type air injection heat exchanger or any combination thereof.

In some embodiments, there are optional additional heat exchanger(s) between the primary heat exchanger and the carbon capture system. In this case, one or more of a combustion air stream or a boiler feed water stream or an oil feed stock stream can be preheated in one or more additional heat exchangers with the cooled effluent stream. The one or more heat exchangers may comprise one or more of a gas/gas heat exchanger or gas/liquid heat exchanger or condensing heat exchanger or a plate type air injection heat exchanger or any combination thereof.

The inlet temperature for the first additional heat exchanger 480 is typically in the range of 100° C.-150° C. with a pressure of −11 kPa(g) to 50 kPa(g). The outlet temperature for the first additional heat exchanger 480 is typically in the range of 45° C.-150° C. with a pressure of −12 kPa(g) to 50 kPa(g).

In some embodiments, the combustion air stream is sent to a CO-combustor.

In some embodiments, a heat recovery steam generator (HRSG) is included before the SO_{X} reaction section. The HRSG comprises a superheated steam section and a saturated steam section. In this case, the waste gas stream comprises a flue gas stream, which is introduced into the superheated steam section of the HRSG to produce a superheated steam stream and a partially cooled flue gas stream. A boiler feed water stream and the partially cooled flue gas stream are introduced into the saturated steam section to produce a saturated steam stream and a second partially cooled flue gas stream. All or a portion of the saturated steam stream is introduced into the superheated steam section, where it is superheated with the flue gas stream to produce the superheated steam stream. The second partially cooled flue gas stream is sent to the SO_{X} reaction section.

Another aspect of the invention is an apparatus for treating a waste gas stream in a process for capturing carbon dioxide, In one embodiment, the apparatus comprises: a SO_{X} reaction section having a gas inlet, a gas outlet, and a reactant inlet, the gas inlet of the sulfur removal section in downstream fluid communication a gas source; a filter section having a gas inlet, a gas outlet, and a filtered material outlet, the gas inlet of the filter section in downstream fluid communication with the gas outlet of the SO_{X} removal section; a NO_{X} reactor section having a gas inlet, a gas outlet, and a reagent inlet, the gas inlet of the NO_{X} reactor section in downstream fluid communication with the gas outlet of the filter section; a primary heat exchanger having a gas inlet, a gas outlet, a second inlet and a second outlet, the gas inlet of the primary heat exchanger in downstream fluid communication with the gas outlet of the NO_{X} reactor section; a carbon capture section having a gas inlet, a second inlet, and an outlet, the gas inlet of the carbon capture section in downstream fluid communication with the gas outlet of the primary heat exchanger, the outlet of the carbon capture section in downstream fluid communication with the second inlet of the primary heat exchanger, the second inlet of the carbon capture section in downstream fluid communication with the second outlet of the primary heat exchanger.

In some embodiments, the apparatus further comprises: an additional heat exchanger having a gas inlet, a gas outlet, a second inlet, and a second outlet, the gas inlet of the additional heat exchanger in downstream fluid communication with the gas outlet of the primary heat exchanger, and the gas outlet in downstream fluid communication with the carbon capture unit, the second inlet of the additional heat exchanger in downstream fluid communication with a source of gas or liquid to be heated, and an end user of the heated gas or liquid in downstream fluid communication with the second outlet of the additional heat exchanger.

In some embodiments, the source of the gas or liquid to be heated comprises a source of boiler feed water or a source of combustion air or a source of oil feedstock, and wherein the end user of the gas or liquid to be heated comprises a boiler feed water end user or a combustion air end user or an oil feedstock end user.

In some embodiments, the apparatus further comprises: a quench/polishing section having a gas inlet, a gas outlet, a second reactant inlet, a saturation water inlet, and a brine product outlet, the gas inlet of the quench/polishing section in downstream fluid communication with the gas outlet of the primary heat exchanger, and the gas inlet of the carbon capture unit in downstream fluid communication with the gas outlet of the quench/polishing section.

In some embodiments, the apparatus further comprises: a heat recovery steam generator (HRSG) comprising a superheated steam section and a saturated steam section, the superheated steam section having a gas inlet, a gas outlet, a saturated steam inlet, and a superheated steam outlet, the saturated steam section having a gas inlet, a gas outlet, a boiler feed water inlet, a blowdown outlet, and a saturated steam outlet, the gas inlet of the saturated steam section in downstream fluid communication with the gas outlet of the superheated steam section, the boiler feed water inlet of the saturated steam section in downstream fluid communication with a source of boiler feed water, the saturated steam inlet of the superheated steam section in downstream fluid communication with the saturated steam outlet of the saturated steam section, and the gas inlet of the SO_{X} reactor section in downstream fluid communication with the gas outlet of the saturated steam section.

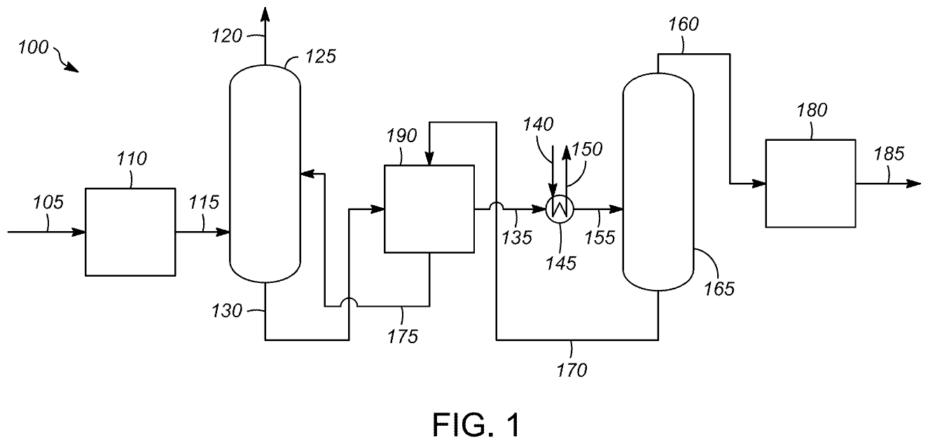

FIG. 1 illustrates one embodiment of a prior art solvent-based carbon capture process 100.

The prior art solvent-based carbon capture process 100 comprises a pre-treatment section 110, an absorber column 125, a heat exchanger network 190, a steam heater 145, a regenerator column 165, and a compressor and cooling system 180.

The flue gas stream 105 is sent to the pre-treatment section 110 where the flue gas contaminates are removed to the specifications of the solvent carbon capture unit.

The purified flue gas stream 115 is sent to the absorber column 125. The absorber column 125 has a second inlet for the cooled lean solvent stream 175 produced by the regenerator column 165. The evacuated purified gas 120 exits through an overhead first outlet. The absorber column bottoms, rich solvent stream 130, exits though a second outlet at the bottom of the absorber column 125.

The rich solvent stream 130 is sent to the heat exchanger network 190 along with the lean solvent stream 170 from the regenerator column 165. The heat exchanger network 190 includes one or more heat exchanger, and in some cases, two or more separate heat exchangers that permits heat transfer between the relatively cool rich solvent stream 130 from the absorber column 125 and the relatively hot lean solvent stream 170 from the regenerator column 165. The heat exchanger network 190 may have direct heat exchangers or indirect heat exchangers or a combination of both. The heat exchanger network 190 has two main outlets: the first outlet is for the heated rich solvent stream 135, and the second outlet is for the cooled lean solvent stream 175. The cooled lean solvent stream 175 is sent to the absorber column 125.

The heated rich solvent stream 135 is sent to the steam heater 145. The steam heater 145 is used to increase the temperature of the heated rich solvent stream 135 by heat exchanging with the steam stream 140 to reach the temperature needed for the regenerator column 165. The first outlet of the steam heater 145 is for the second heated rich solvent stream 155. The second outlet of the steam heater 145 is for the steam condensate 150 which is returned to the stream generation system (not shown) of the main process.

The second heated rich solvent stream 155 from the steam heater 145 is sent to the regenerator column 165. The regenerator column 165 is a gas/liquid contactor using trays, structured packing, random packing and/or sprays in any combination to achieve countercurrent contacting. The stripped acid gas vapor stream 160 exits the regenerator column 165 through an overhead outlet. The lean solvent stream 170 exits the regenerator column 165 though a second outlet at the bottom of the column.

The stripped acid gas vapor stream 160 is sent to the compressor and cooler system 180 where the stripped acid gas vapor stream 160 is compressed and cooled to the final product specification. The outlet of the compressor and cooler system 180 is the final captured carbon dioxide product stream 185.

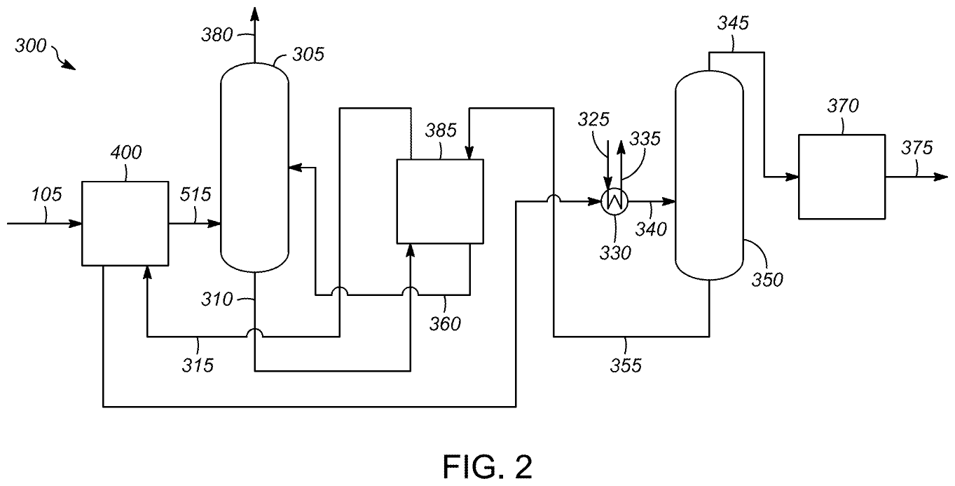

FIG. 2 illustrates one embodiment of a solvent carbon capture process 300 according to the present invention.

The solvent carbon capture process 300 comprises the waste gas treatment section 400, an absorber column 305, a heat exchanger network 385, a steam heater 330, a regenerator column 350, and a compressor and cooling section 370.

The waste gas stream 105 is sent to the waste gas treatment section 400 where the flue gas contaminates are removed to the specifications of the solvent carbon capture process 100. The details of the waste gas treatment section 400 will be discussed further below.

The purified gas stream 515 is sent to the absorber column 305. The absorber column 305 has a second inlet for the cooled lean solvent stream 360 produced by the regenerator column 350. The is evacuated rich solvent 380 through an overhead first outlet. The absorber column bottoms, rich solvent stream 310, exits through a second outlet at the bottom of the absorber column 305.

The rich solvent stream 310 is sent to the heat exchanger network 385 along with the lean solvent stream 355 from the regenerator column 350. The heat exchanger network 385 includes one or more heat exchanger, and in some cases two or more separate heat exchangers that permits heat transfer between the relatively cool rich solvent stream 310 from the absorber column 305 and the relatively hot lean solvent stream 355 from the regenerator column 350. The heat exchanger network 385 may have direct heat exchangers or indirect heat exchangers or a combination of both. The heat exchanger network 385 has two main outlets: the first outlet is for the heated rich solvent stream 315, the second outlet is for the cooled lean solvent stream 360. The cooled lean solvent stream 360 is sent to the absorber column 305.

The heated rich solvent stream 315 from the heat exchanger network 385 is sent to the waste gas treatment section 400.

The pre-heated rich solvent stream 320 from the waste gas treatment section 400 is sent to the steam heater 330. The steam heater 330 is used to increase the temperature of the pre-heated rich solvent stream 320 by heat exchanging with the steam stream 325 to reach the temperature needed for the regenerator column 350. The first outlet of the steam heater 330 is for the third heated rich solvent stream 340. The second outlet of the steam heater 330 is for the steam condensate 335 which is returned to the stream generation system (not shown) of the main process.

The third heated rich solvent stream 340 from the steam heater 330 is sent to the regenerator column 350. The regenerator column 350 is a gas/liquid contactor using trays, structured packing, random packing and/or sprays in any combination to achieve countercurrent contacting. The stripped acid gas vapor stream 345 exits the regenerator column 350 through an overhead outlet. The lean solvent stream 355 exits the regenerator column 350 through a second outlet at the bottom of the column.

The stripped acid gas vapor stream 345 is sent to the compressor and cooler system 370 where the stripped acid gas vapor steam 345 is compressed and cooled to the final product specification. The outlet of the compressor and cooler system 370 is the final captured carbon dioxide product stream 375.

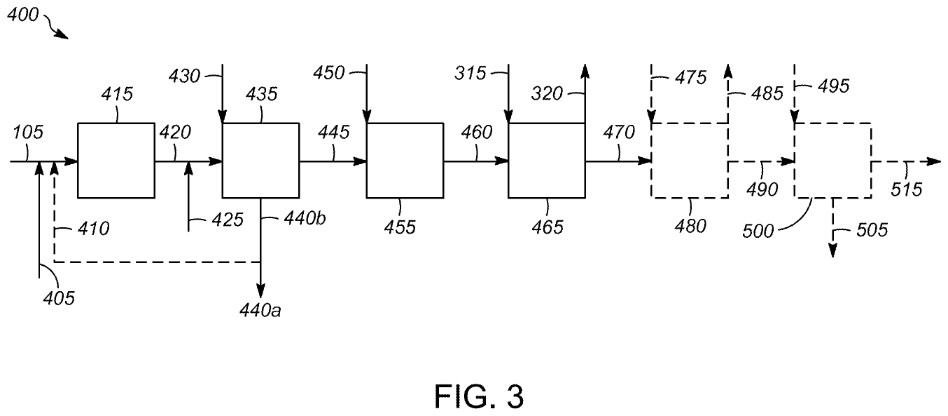

FIG. 3 illustrates one embodiment of a waste gas treatment section 400 according to the present invention. The waste gas treatment section 400 comprises a SO_{X} reaction section 415, a filtration section 435, a NO_{X} reactor section 455, a primary heat exchanger 465, an optional additional heat exchanger 480, and an optional combined quench/polishing column 500.

The waste gas stream 105 is mixed with the following: Fresh sorbent 405 and optionally recycled sorbent 410 (comprising a mixture of one or more of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), organic acids, heavy metals catalyst fines, and fine particulate matter, depending on the compounds present in the flue gas and the reactant used, as discussed below) sent to the SO_{X} reaction section 415 to convert one or more of the compounds in the waste gas stream 105. The inlet temperature for the SO_{X} reaction section 415 is typically in the range of 200° C.-400° C. with a pressure of −3 kPa(g) to 50 kPa(g). The outlet temperature for the SO_{X} reaction section 415 is typically in the range of 150° C.-400° C. with a pressure of −5 kPa(g) to 50 kPa(g). For example, the SO_{X} reaction section 415 may contain a reactant, such as one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂). The reactant reacts with one or more of N₂, O₂, Cl₂, CO₂, H₂O, CO, NO_{X}, SO_{X}, fine particulate matter, catalyst fines, organic acids, heavy metals, dioxins, and furans in the incoming waste gas steam 105. The SO_{X} reactor effluent stream 420 has a reduced content of one or more of the compounds compared to the incoming waste gas stream 105.

The SO_{X} reactor effluent stream 420 is combined with a quench stream 425 comprising air, and/or water, and/or quenched waste gas. The quenched SO_{X} reactor effluent stream 420 is sent to the filtration section 435 for the removal of one or more of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, catalyst fines, organic acids, heavy metals and fine particulate matter. The inlet temperature for the filtration section 435 is typically in the range of 150° C.-350° C. with a pressure of −5 kPa(g) to 50 kPa(g). The outlet temperature for the filtration section 435 is typically in the range of 150° C.-350° C. with a pressure of −7 kPa(g) to 50 kPa(g). The filtration section 435 comprises a bag filter, and/or a ceramic filter, and/or an electrostatic precipitator. An instrument air purge or high voltage DC 430 is introduced into the filtration section 435. In the case of the instrument air purge, it purges the retained material from the filter. In the case of the high voltage stream, it charges the cathodes of the ESP. The particulate is removed from the ESP by vibration. A filtered material stream 440 comprising of one or more CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, catalyst fines, organic acids, heavy metals and fine particulate matter exits the filtration section 435. Alternatively, or additionally, a portion the filtered material 440 can be recycled to the SO_{X} reaction section 415 as recycled sorbent stream 410 to increase the conversion yield of the reactant (i.e. from 85 wt % to 98 wt %). In the case where there is a recycled portion of the filtered material 440, the remainder of the filtered material stream 440 can be removed from the process.

The filtered SO_{X} reactor effluent stream 445 is sent to the NO_{X} reactor section 455. In this configuration, NO_{X} reactor section 455 is a selective catalytic reduction (SCR) section. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. The inlet temperature for the NO_{X} reactor section 455 is typically in the range of 150° C.-300° C. with a pressure of −8 kPa(g) to 50 kPa(g). The outlet temperature for the NO_{X} reactor section 455 is typically in the range of 150° C.-350° C. with a pressure of −9 kPa(g) to 50 kPa(g). An ammonia and/or urea stream 450 is introduced into the NO_{X} reactor section 455 where it reacts with the NO_{X} present in the filtered SO_{X} reactor effluent stream 445. The NO_{X} reactor effluent stream 460 has a reduced content of one or more of the compounds compared to the incoming filtered SO_{X} reactor effluent stream 445.

The NO_{X} reactor effluent stream 460 is sent to the primary heat exchanger 465 and cooled with a heated rich solvent stream 315 from the solvent carbon capture system to form a pre-heated rich solvent stream 320. The pre-heated rich solvent stream 320 is sent back to the carbon capture system. The inlet temperature for the primary heat exchanger 465 is typically in the range of 150° C.-350° C. with a pressure of −9 kPa(g) to 50 kPa(g). The outlet temperature for the primary heat exchanger 465 is typically in the range of 100° C.-150° C. with a pressure of −11 kPa(g) to 50 kPa(g).

The cooled effluent stream 470 is sent to an optional additional heat exchanger 480 where cooled effluent stream 470 is further cooled with stream 475 to form a heated stream 485. The heated stream 485 can be sent to any appropriate end user for the particular stream. Stream 475 can be boiler feed water, combustion air, or an oil feed stock, for example. If the heated stream (485) is boiler feed water, it can be sent to the saturated steam section of a heat recovery steam generator (HRSG), for example. If the heated stream (485) is combustion air, it can be sent to a CO-combustor, for example. If the heated stream (485) is oil feed stock, it can be sent to the hot oil system of the main process unit, for example. Alternately, or additionally, all or a portion the heated stream 485 can be sent to other areas of the plant as needed. For example, if the waste gas stream 105 is a flue gas stream from a fluid catalytic cracking (FCC) unit, the heated boiler feed water could be sent to a catalyst cooler in the regenerator section, the main column bottoms steam generator, reboiler in a downstream solvent-based CO₂ capture plant, and the like. The inlet temperature for the first additional heat exchanger 480 is typically in the range of 100° C.-150° C. with a pressure of −11 kPa(g) to 50 kPa(g). The outlet temperature for the first additional heat exchanger 480 is typically in the range of 45° C.-150° C. with a pressure of −12 kPa(g) to 50 kPa(g).

There can be one or more additional heat exchangers 480. If more than one additional heat exchanger is present, the temperatures and pressures would be reduced with each heat exchanger.

The effluent stream 490 from the (one or more) additional heat exchanger 480 is sent to an optional combined quench/polishing column 500 where the temperature of the effluent is reduced to the saturation temperature using an aqueous second reactant solution where it will react with one or more of SO_{X}, HCl and Cl₂ in the effluent stream 490. The inlet temperature for the combined quench/polishing column 500 is typically in the range of 45° C.-150° C. with a pressure of −12 kPa(g) to 50 kPa(g). The outlet temperature for the combined quench/polishing column 500 is typically in the range of 45° C.-75° C. with a pressure of −15 kPa(g) to 50 kPa(g). The aqueous second reactant solution 495 includes, but is not limited to, water, air, recycle flue gas, second reactant or combinations thereof. An aqueous brine solution stream 505 containing one or more of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, catalyst fines, organic acids, heavy metals, and fine particulate matter exits the combined quench/polishing column 500. If desired, a reducing agent such as NaHSO₃ or H₂O₂, can be included to react with the Cl₂ to form HCl which reacts to form NaCl. The quench/polishing purified gas stream 515 has a reduced level of one or more of SO_{X}, HCl and Cl₂ compared to the incoming effluent stream 490. The purified gas stream 515 from the combined quench/polishing column is sent to the absorber column 305 of the carbon capture system.

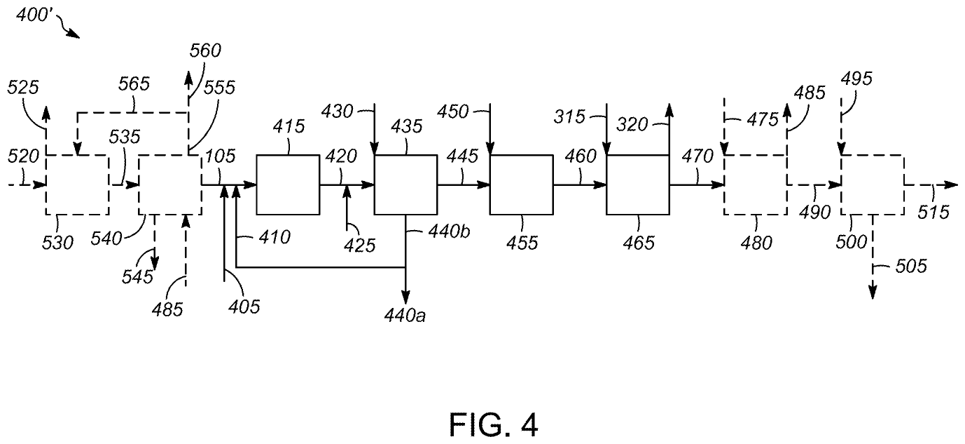

FIG. 4 illustrates another embodiment of a waste gas treatment section 400′ according to the present invention. The waste gas is flue gas from a fluidized catalytic cracking (FCC) process unit, and the waste gas treatment section 400′ includes a heat recovery steam generator (HRSG) in addition to the sections discussed above.

The HRSG has a superheated steam section 530 and a saturated steam section 540. The inlet flue gas stream 520 is sent to the superheated steam section 530 of the HRSG. The inlet flue gas temperature ranges from 650-1100° C.

The partially cooled flue gas stream 535 is sent to the saturated steam section 540 of the HRSG. The preheated boiler feed water stream 485 from the additional heat exchanger 480 is heated by the partially cooled flue gas stream 535 forming a saturated steam stream 555 and condensate stream 545.

A portion 565 of the saturated steam stream 555 is sent to the superheated steam section 530. The remainder 560 of the saturated steam stream 555 can be sent to other parts of the plant for use as needed.

The effluent from the saturated steam section 540 is sent to the rest of the process as discussed above.

### EXAMPLES

### Example 1—Thermal Energy Recovery—Primary Heat Exchanger

A simulation was performed assuming a partial recovery fluidized catalytic cracking (FCC) process unit waste heat steam generator (WHSG) outlet flue gas waste stream.

In the base case, the inlet of the steam heater (144° C.) is the outlet of the heat exchanger network system. Steam heater requires 269 MMBtu/hr to heat the rich solvent stream to meet the requirements of the regenerator column (152° C.).

With the heat integration of the present invention, the solvent outlet of the heat exchanger network system (144° C.) is integrated with the outlet of the NO_{X} reactor (291ºC). The solvent outlet of the integrated exchanger is heated to)(149° C. and sent back to the steam heater of the solvent-based carbon capture network. The steam heater heats the solvent to the inlet temperature of the regenerator column of 152° C.

TABLE 1

| Steam Heater of | | | |
|---|---|---|---|
| Carbon Capture | | | |
| Unit | Base Case | Invention | % Difference |
| Duty (MMBtu/hr) | 269 | 183 | 36 |
| CAPEX ($M) | 17.7 | 14.0 | 20 |
| OPEX ($M/yr) | 40 | 28 | 29 |
| Carbon Intensity | 132,534 | 90,163 | 32 |
| (MT/yr) | | | |

### Example 2—Quench Water Usage

A simulation was performed assuming a partial recovery fluidized catalytic cracking (FCC) process unit waste heat steam generator (WHSG) outlet flue gas waste stream.

The base case has a treatment configuration of a wet gas scrubber as the first treatment step. The invention has a Dry Sorbent Injection unit (DSI) followed by a SCR and a primary exchanger. The base case is the inlet flue gas. The invention inlet is downstream of the primary exchanger. Table 2 shows the column inlet conditions for each case.

TABLE 2

| | |
|---|---|
| Base Case | Invention |

Temperature (° C.)

| | |
|---|---|
| 198 | 143 |

kg/hr

| | | |
|---|---|---|
| CO | 592 | 592 |
| CO₂ | 133,226 | 134,333 |
| H₂O | 54,200 | 54,501 |
| O₂ | 11,956 | 815 |
| N₂ | 423,020 | 423,020 |
| SOₓ | 395 | 8 |
| NOₓ | 161 | 1 |
| Total | 623,550 | 613,262 |

Table 3 shows that the original process flow scheme with a partial combustion FCC regenerator requires 415,400 MT/yr of saturation quench water due to the configuration of the waste treatment (inlet of column is 198° C.) and adiabatic saturation temperature. With the flow scheme of the present invention, the flue gas would be entering the quench polishing column at 143ºC which would require about 186,700 MT/yr. This would be about a 55% reduction (Δ 228,700 MT/yr) in saturation quench water. The change in operating cost for saturation water in Europe would be $110,000. The change in saturation quench water requirements would be directly related to a carbon intensity savings of 426 MT/yr.

TABLE 3

| | Base Case | Invention | % Difference |
|---|---|---|---|
| Saturation Quench | 415,400 | 186,700 | 55 |
| Water Consumption | | | |
| (MT/yr) | | | |
| OPEX ($M/yr) | 0.21 | 0.09 | 57 |
| Carbon Intensity | 721 | 295 | 60 |
| (MT/yr) | | | |

### Example 3—Thermal Energy Recovery—Additional Heat Exchanger

A simulation was performed assuming a partial recovery fluidized catalytic cracking (FCC) process unit heat recovery steam generator (HRSG) outlet flue gas waste stream. The base case is assuming the conventional flue gas treatment process.

In the base case, the temperature in the HRSG is reduced from 982° C. (1800° F.) to 200° C. (392° F.), leading to recovery of 547 MMBTU/hr.

Using the configuration of the present invention, the inlet flue gas temperature 982° C. (1800° F.) is reduced to 149° C. (300° F.), leading to a recovery of 601 MMBTU/hr. This is a 10% increase in energy recovery (54 MMBTU/hr). The ability to increase the energy recovery is related to the decreased acid due point temperature of the flue gas waste steam (increased removal of SO₃ in the DSI). The increase in energy recovery is directly related to a decrease of 26,605 MT/yr carbon emissions.

TABLE 4

| | Base Case | Invention | % Difference |
|---|---|---|---|
| HRSG Outlet | 200 | 149 | |
| Temperature (° C.) | | | |
| Recovered Energy | 547 | 601 | 10 |
| (MMBTU/hr) | | | |
| Carbon Emission | 269,502 | 296,108 | 9 |
| Reduction (MT/yr) | | | |

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include one processor and memory storing computer-readable instructions that, when executed by the one or more processor, cause the one or more computing devices to perform a process that may include one or more steps. For example, the one or more computing devices may be configured to receive, from one or more monitoring component, data related to one or more piece of equipment associated with the process. The one or more computing devices or systems may be configured to analyze the data. Based on analyzing the data, the one or more computing devices or systems may be configured to determine one recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc., were not shown in the drawings as it is believed that the specifics of same are well within the knowledge of those of ordinary skill in the art and a description of same is not necessary for practicing or understanding the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

By the term “about,” we mean within 10% of the value, or within 5%, or within 1%. As used herein, the terms “unit,” “zone,” and “section” can refer to an area including one or more equipment items as appropriate for the type of unit, zone, or section and/or one or more sub-zones or sub-sections. Equipment items can include, but are not limited to, one or more reactors or reactor vessels, separation vessels, adsorbent chamber or chambers, distillation towers, heaters, exchangers, pipes, pumps, compressors, and controllers. Additionally, an equipment item, such as a reactor, dryer, adsorbent chamber or vessel, can further include one or more sections, sub-sections, zones, or sub-zones.

### Specific Embodiments

While the following is described in conjunction with specific embodiments, it will be understood that this description is intended to illustrate and not limit the scope of the preceding description and the appended claims.

A first embodiment of the invention is a method for treating a waste gas stream in a process for capturing carbon dioxide wherein the waste gas stream comprises one or more of H₂O, CO₂, CO, N₂, O₂, SO_{X}, NO_{X}, HCl, Cl₂, dioxins, furans, organic acids, heavy metals, catalyst fines, and fine particulate matter, the method comprising reacting one or more of H₂O, CO₂, CO, N₂, O₂, SO_{X}, NO_{X}, HCl, Cl₂, dioxins, furans, catalyst fines, fine particulate matter or a mixture thereof in the waste gas stream with a reactant in an SO_{X} reaction section comprising a dry sorbent injection (DSI) reactor, wherein the reactant comprises one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂) to form a SO_{X} reactor effluent stream comprising one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), dioxins, furans, organic acids, heavy metals, catalyst fines, and fine particulate matter; filtering the SO_{X} reactor effluent stream to remove one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂)), dioxins, furans, organic acids, heavy metals, catalyst fines and fine particulate matter to form a filtered SO_{X} reactor effluent stream; reacting one or more of H₂O, CO₂, CO, N₂, O₂, dioxins, furans, organic acids, heavy metals, catalyst fine, and fine particulate matter in the filtered SO_{X} reactor effluent stream in a NO_{X} reactor section comprising a selective catalytic reduction (SCR) reactor to form a NO_{X} reactor effluent stream with a reduced level of nitrogen-containing compounds compared to the SO_{X} reactor effluent stream; optionally removing dioxin, furan, or both from the NO_{X} reactor effluent stream in a dioxin-furan removal section to form a treated NO_{X} reactor effluent stream consisting essentially of one or more of H₂O, CO₂, CO, N₂, and O₂; pre-heating a rich solvent stream from a carbon capture section with the NO_{X} reactor effluent stream or the treated NO_{X} reactor effluent stream thereby reducing a temperature to 130° C. to 200° C. and staying above the dew point of water forming a cooled effluent stream and a pre-heated rich solvent stream; and introducing the cooled effluent stream into the carbon capture section. An embodiment of the invention is one, any or all of prior embodiments in this paragraph up through the first embodiment in this paragraph further comprising quenching the cooled effluent stream in the quench section of a combined quench/polishing column to form a quenched stream before introducing the cooled effluent stream into the carbon capture section, and contacting a second reactant with the quenched stream in the polishing section of the combined quench/polishing column to form a liquid waste stream and a purified outlet gas stream with a reduced temperature compared to the cooled effluent stream, wherein the liquid waste stream comprises one or more of H₂O, Na₂SO₄, Na₂SO₄, NaHSO₃, Na₂CO₃, CaSO₄, CaCO₃, K₂SO₄, and K₂CO₃, wherein the second reactant comprises one or more of NaOH, KOH, CaOH, NaHCO₃, Na₂CO₃, NaHCO₃·Na₂CO₃·2(H₂O), CaCO₃ and Ca(OH)₂; and wherein introducing the cooled effluent stream into the carbon capture section comprises introducing the purified outlet gas stream into the carbon capture section An embodiment of the invention is one, any or all of prior embodiments in this paragraph up through the first embodiment in this paragraph wherein filtering the SO_{X} reactor effluent stream comprises filtering the SO_{X} reactor effluent stream using a bag filter or an electrostatic precipitator. An embodiment of the invention is one, any or all of prior embodiments in this paragraph up through the first embodiment in this paragraph wherein filtering the SO_{X} reactor effluent stream further forms a filter material stream, and further comprising dividing the filter material stream into two portions; recycling a first portion to the DSI reactor; and recovering the second portion. An embodiment of the invention is one, any or all of prior embodiments in this paragraph up through the first embodiment in this paragraph wherein pre-heating the rich solvent stream with the filtered NO_{X} reactor effluent stream or the treated outlet stream comprises pre-heating the rich solvent stream using a gas/gas heat exchanger or a gas/liquid heat exchanger or a condensing heat exchanger or a plate type air injection heat exchanger or any combination thereof. An embodiment of the invention is one, any or all of prior embodiments in this paragraph up through the first embodiment in this paragraph further comprising pre-heating one or more of a combustion air stream or a boiler feed water stream or an oil feed stock stream in one or more additional heat exchangers with the cooled effluent stream located between the primary heat exchanger and the carbon capture system, wherein the one or more additional heat exchangers comprise one or more of a gas/gas heat exchanger or gas/liquid heat exchanger or condensing heat exchanger or a plate type air injection heat exchanger or any combination thereof. An embodiment of the invention is one, any or all of prior embodiments in this paragraph up through the first embodiment in this paragraph wherein the combustion air stream is sent to a CO-combustor. An embodiment of the invention is one, any or all of prior embodiments in this paragraph up through the first embodiment in this paragraph wherein the waste gas stream comprises a flue gas stream, further comprising introducing the flue gas stream into a superheated steam section of a heat recovery steam generator (HRSG) before the SO_{X} reaction section to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of H₂O, CO₂, CO, N₂, O₂, SO_{X}, NO_{X}, HCl, Cl₂, dioxins, furans, catalyst fines, fine particulate matter or a mixture thereof in the waste gas stream with a reactant in an SO_{X} reaction section comprises reacting one or more of H₂O, CO₂, CO, N₂, O₂, SO_{X}, NO_{X}, HCl, Cl₂, dioxins, furans, catalyst fines, fine particulate matter or a mixture thereof in the second partially cooled flue gas stream with the reactant.

A second embodiment of the invention is an apparatus for treating a waste gas stream in a process for capturing carbon dioxide comprising a SO_{X} reaction section having a gas inlet, a gas outlet, and a reactant inlet, the gas inlet of the sulfur removal section in downstream fluid communication a gas source; a filter section having a gas inlet, a gas outlet, and a filtered material outlet, the gas inlet of the filter section in downstream fluid communication with the gas outlet of the SO_{X} removal section; a NO_{X} reactor section having a gas inlet, a gas outlet, and a reagent inlet, the gas inlet of the NO_{X} reactor section in downstream fluid communication with the gas outlet of the filter section; a primary heat exchanger having a gas inlet, a gas outlet, a second inlet and a second outlet, the gas inlet of the primary heat exchanger in downstream fluid communication with the gas outlet of the NO_{X} reactor section; a carbon capture section having a gas inlet, a second inlet, and an outlet, the gas inlet of the carbon capture section in downstream fluid communication with the gas outlet of the primary heat exchanger, the outlet of the carbon capture section in downstream fluid communication with the second inlet of the primary heat exchanger, the second inlet of the carbon capture section in downstream fluid communication with the second outlet of the primary heat exchanger. An embodiment of the invention is one, any or all of prior embodiments in this paragraph up through the second embodiment in this paragraph further comprising an additional heat exchanger having a gas inlet, a gas outlet, a second inlet, and a second outlet, the gas inlet of the additional heat exchanger in downstream fluid communication with the gas outlet of the primary heat exchanger, and the gas outlet in downstream fluid communication with the carbon capture unit, the second inlet of the additional heat exchanger in downstream fluid communication with a source of gas or liquid to be heated, and an end user of the heated gas or liquid in downstream fluid communication with the second outlet of the additional heat exchanger. An embodiment of the invention is one, any or all of prior embodiments in this paragraph up through the second embodiment in this paragraph wherein the source of the gas or liquid to be heated comprises a source of boiler feed water or a source of combustion air or a source of oil feedstock, and wherein the end user of the gas or liquid to be heated comprises a boiler feed water end user or a combustion air end user or an oil feedstock end user. An embodiment of the invention is one, any or all of prior embodiments in this paragraph up through the second embodiment in this paragraph further comprising a quench/polishing section having a gas inlet, a gas outlet, a second reactant solution inlet, a saturation water inlet, and a brine product outlet, the gas inlet of the quench/polishing section in downstream fluid communication with the gas outlet of the primary heat exchanger, and the gas inlet of the carbon capture unit in downstream fluid communication with the gas outlet of the quench/polishing section. An embodiment of the invention is one, any or all of prior embodiments in this paragraph up through the second embodiment in this paragraph further comprising a heat recovery steam generator (HRSG) comprising a superheated steam section and a saturated steam section, the superheated steam section having a gas inlet, a gas outlet, a saturated steam inlet, and a superheated steam outlet, the saturated steam section having a gas inlet, a gas outlet, a boiler feed water inlet, a blowdown outlet, and a saturated steam outlet, the gas inlet of the saturated steam section in downstream fluid communication with the gas outlet of the superheated steam section, the boiler feed water inlet of the saturated steam section in downstream fluid communication with a source of boiler feed water, the saturated steam inlet of the superheated steam section in downstream fluid communication with the saturated steam outlet of the saturated steam section, and the gas inlet of the SO_{X} reactor section in downstream fluid communication with the gas outlet of the saturated steam section.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method for treating a waste gas stream in a process for capturing carbon dioxide wherein the waste gas stream comprises one or more of H₂O, CO₂, CO, N₂, O₂, SO_{X}, NO_{X}, HCl, Cl₂, dioxins, furans, organic acids, heavy metals, catalyst fines, and fine particulate matter, the method comprising:
reacting one or more of H₂O, CO₂, CO, N₂, O₂, SO_{X}, NO_{X}, HCl, Cl₂, dioxins, furans, catalyst fines, fine particulate matter or a mixture thereof in the waste gas stream with a reactant in an SO_{X} reaction section comprising a dry sorbent injection (DSI) reactor, wherein the reactant comprises one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂) to form a SO_{X} reactor effluent stream comprising one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), dioxins, furans, organic acids, heavy metals, catalyst fines, and fine particulate matter;
filtering the SO_{X} reactor effluent stream to remove one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂)), dioxins, furans, organic acids, heavy metals, catalyst fines and fine particulate matter to form a filtered SO_{X} reactor effluent stream;
reacting one or more of H₂O, CO₂, CO, N₂, O₂, dioxins, furans, organic acids, heavy metals, catalyst fine, and fine particulate matter in the filtered SO_{X} reactor effluent stream in a NO_{X} reactor section comprising a selective catalytic reduction (SCR) reactor to form a NO_{X} reactor effluent stream with a reduced level of nitrogen-containing compounds compared to the SO_{X} reactor effluent stream;
optionally removing dioxin, furan, or both from the NO_{X} reactor effluent stream in a dioxin-furan removal section to form a treated NO_{X} reactor effluent stream consisting essentially of one or more of H₂O, CO₂, CO, N₂, and O₂;
pre-heating a rich solvent stream from a carbon capture section with the NO_{X} reactor effluent stream or the treated NO_{X} reactor effluent stream thereby reducing a temperature to 130° C. to 200° C. and staying above the dew point of water forming a cooled effluent stream and a pre-heated rich solvent stream; and
introducing the cooled effluent stream into the carbon capture section.

2. The method of claim 1 further comprising:
quenching the cooled effluent stream in the quench section of a combined quench/polishing column to form a quenched stream before introducing the cooled effluent stream into the carbon capture section, and contacting a second reactant with the quenched stream in the polishing section of the combined quench/polishing column to form a liquid waste stream and a purified outlet gas stream with a reduced temperature compared to the cooled effluent stream, wherein the liquid waste stream comprises one or more of H₂O, Na₂SO₄, Na₂SO₄, NaHSO₃, Na₂CO₃, CaSO₄, CaCO₃, K₂SO₄, and K₂CO₃, wherein the 10 second reactant comprises one or more of NaOH, KOH, CaOH, NaHCO₃, Na₂CO₃, NaHCO₃·Na₂CO₃·2(H₂O), CaCO₃ and Ca(OH)₂; and
wherein introducing the cooled effluent stream into the carbon capture section comprises introducing the purified outlet gas stream into the carbon capture section.

3. The method of claim 1 wherein filtering the SO_{X} reactor effluent stream comprises filtering the SO_{X} reactor effluent stream using a bag filter or an electrostatic precipitator.

4. The method of claim 1 wherein filtering the SO_{X} reactor effluent stream further forms a filter material stream, and further comprising:
dividing the filter material stream into two portions;
recycling a first portion to the DSI reactor; and
recovering the second portion.

5. The method of claim 1 wherein pre-heating the rich solvent stream with the filtered NO_{X} reactor effluent stream or the treated outlet stream comprises pre-heating the rich solvent stream using a gas/gas heat exchanger or a gas/liquid heat exchanger or a condensing heat exchanger or a plate type air injection heat exchanger or any combination thereof.

6. The method of claim 1 further comprising:
pre-heating one or more of a combustion air stream or a boiler feed water stream or an oil feed stock stream in one or more additional heat exchangers with the cooled effluent stream located between the primary heat exchanger and the carbon capture system, wherein the one or more additional heat exchangers comprise one or more of a gas/gas heat exchanger or gas/liquid heat exchanger or condensing heat exchanger or a plate type air injection heat exchanger or any combination thereof.

7. The method of claim 6 wherein the combustion air stream is sent to a CO-combustor.

8. The method of claim 1 wherein the waste gas stream comprises a flue gas stream, further comprising:
introducing the flue gas stream into a superheated steam section of a heat recovery steam generator (HRSG) before the SO_{X} reaction section to produce a superheated steam stream and a partially cooled flue gas stream, the HRSG comprising the superheated steam section and a saturated steam section;
introducing a boiler feed water stream and the partially cooled flue gas stream into the saturated steam section to produce a saturated steam stream and a second partially cooled flue gas stream;
introducing at least a portion of the saturated steam stream into the superheated steam section;
superheating the saturated steam stream with the flue gas stream to produce the superheated steam stream; and
wherein reacting one or more of H₂O, CO₂, CO, N₂, O₂, SO_{X}, NO_{X}, HCl, Cl₂, dioxins, furans, catalyst fines, fine particulate matter or a mixture thereof in the waste gas stream with a reactant in an SO_{X} reaction section comprises reacting one or more of H₂O, CO₂, CO, N₂, O₂, SO_{X}, NO_{X}, HCl, Cl₂, dioxins, furans, catalyst fines, fine particulate matter or a mixture thereof in the second partially cooled flue gas stream with the reactant.

9. An apparatus for treating a waste gas stream in a process for capturing carbon dioxide comprising:
a SO_{X} reaction section having a gas inlet, a gas outlet, and a reactant inlet, the gas inlet of the sulfur removal section in downstream fluid communication a gas source;
a filter section having a gas inlet, a gas outlet, and a filtered material outlet, the gas inlet of the filter section in downstream fluid communication with the gas outlet of the SO_{X} removal section;
a NO_{X} reactor section having a gas inlet, a gas outlet, and a reagent inlet, the gas inlet of the NO_{X} reactor section in downstream fluid communication with the gas outlet of the filter section;
a primary heat exchanger having a gas inlet, a gas outlet, a second inlet and a second outlet, the gas inlet of the primary heat exchanger in downstream fluid communication with the gas outlet of the NO_{X} reactor section; and
a carbon capture section having a gas inlet, a second inlet, and an outlet, the gas inlet of the carbon capture section in downstream fluid communication with the gas outlet of the primary heat exchanger, the outlet of the carbon capture section in downstream fluid communication with the second inlet of the primary heat exchanger, the second inlet of the carbon capture section in downstream fluid communication with the second outlet of the primary heat exchanger.

10. The apparatus of claim 9 further comprising:
an additional heat exchanger having a gas inlet, a gas outlet, a second inlet, and a second outlet, the gas inlet of the additional heat exchanger in downstream fluid communication with the gas outlet of the primary heat exchanger, and the gas outlet in downstream fluid communication with the carbon capture unit, the second inlet of the additional heat exchanger in downstream fluid communication with a source of gas or liquid to be heated, and an end user of the heated gas or liquid in downstream fluid communication with the second outlet of the additional heat exchanger.

11. The apparatus of claim 9 wherein the source of the gas or liquid to be heated comprises a source of boiler feed water or a source of combustion air or a source of oil feedstock, and wherein the end user of the gas or liquid to be heated comprises a boiler feed water end user or a combustion air end user or an oil feedstock end user.

12. The apparatus of claim 9 further comprising:
a quench/polishing section having a gas inlet, a gas outlet, a second reactant solution inlet, a saturation water inlet, and a brine product outlet, the gas inlet of the quench/polishing section in downstream fluid communication with the gas outlet of the primary heat exchanger, and the gas inlet of the carbon capture unit in downstream fluid communication with the gas outlet of the quench/polishing section.

13. The apparatus of claim 9 further comprising:
a heat recovery steam generator (HRSG) comprising a superheated steam section and a saturated steam section, the superheated steam section having a gas inlet, a gas outlet, a saturated steam inlet, and a superheated steam outlet, the saturated steam section having a gas inlet, a gas outlet, a boiler feed water inlet, a blowdown outlet, and a saturated steam outlet, the gas inlet of the saturated steam section in downstream fluid communication with the gas outlet of the superheated steam section, the boiler feed water inlet of the saturated steam section in downstream fluid communication with a source of boiler feed water, the saturated steam inlet of the superheated steam section in downstream fluid communication with the saturated steam outlet of the saturated steam section, and the gas inlet of the SO_{X} reactor section in downstream fluid communication with the gas outlet of the saturated steam section.
